(19) United States
(12) Patent Application Publication
(10) Pub. No.: US 2015/0052905 A1
(43) Pub. Date: Feb. 26, 2015

(54) Pulse Width Modulation for Control of Late Lean Liquid Injection Velocity

(71) Applicant: General Electric Company, Schenectady, NY (US)

(72) Inventors: William Francis Carnell, JR., Greenville, SC (US); Ilya Aleksandrovich Slobodyanskiy, Greenville, SC (US)

(73) Assignee: General Electric Company, Schenectady, NY (US)

(21) Appl. No.: 13/971,309

(22) Filed: Aug. 20, 2013

(51) Int. Cl. F02C 7/22

(52) U.S. Cl. CPC F02C 7/22
USPC 60/776; 60/734

(57) ABSTRACT

Systems and methods for pulse-width modulation of late lean liquid injection velocity can be provided by certain embodiments of the disclosure. In one embodiment, a gas turbine combustor utilizing a late lean injection scheme can be provided, wherein the combustor can include a combustor liner and a transition piece. Methods described herein can allow for dynamic and intelligent adjustment of the late lean injection scheme based on a duty cycle and, optionally, a measured combustion gases temperature profile. The adjustments can involve a pulse-width modification of the duty cycle, which in turn can affect a fuel introduction velocity. Dynamic control of the fuel introduction velocity can provide for improved fuel droplet penetration and moving the heat release zone away from walls of the transitional piece.

### TECHNICAL FIELD

This application relates generally to gas turbine combustors and, more specifically, to pulse-width modulation (PWM) for control of late lean injection velocity.

### BACKGROUND

Conventionally, gas turbines include a compressor, one or more combustors, a fuel injection system, and a multi-stage turbine section. In operation, the compressor pressurizes inlet air which is then flown to or from the combustor(s) to cool down the combustor(s) and also to provide air for the combustion process. In some multi-combustor turbines, the one or more combustors are located in a circular arrangement around the turbine rotor. Transition pieces, also known as transition ducts, can be used to deliver combustion gases from each of the combustors to the first stage of the turbine section.

Specifically, in a typical gas turbine configuration, each combustor includes a substantially cylindrical combustor casing affixed to the turbine casing. Each combustor may also include a flow sleeve and a combustor liner arranged substantially concentrically within the flow sleeve. Both the flow sleeve and the combustor liner can extend between a double-walled transition duct at their downstream or aft end and a combustor liner cap assembly at their upstream or forward end. The outer wall of the transition duct and a portion of the flow sleeve can be provided with an arrangement of cooling air supply holes over a substantial portion of their respective surfaces, thereby permitting compressor air to enter the radial space between the inner and outer walls of the transition piece and between the combustor liner and the flow sleeve, and to be reverse-flown to the upstream portion of the combustor, where the airflow is again reversed to flow through the cap assembly and into the combustion chamber within the combustor liner. Dry low NOx (DLN) gas turbines typically utilize dual-fuel combustors that provide both liquid and gas fuel capability. One commonly used arrangement includes five dual-fuel nozzles surrounding a center dual-fuel nozzle, arranged to supply fuel and air to the combustion chamber.

In various operating conditions, however, and in order to attain a high operating efficiency of the multi-stage turbine section, it may be desirable to maintain relatively high combustion gas temperatures for introduction of the gas into the turbine first stage. Moreover, in many arrangements, it may be desirable to have a specific temperature profile of combustion gases when the combustion gases enter the turbine first stage. However, maintaining combustion gas temperatures at the desired levels may be a difficult task.

One temperature profile controlling method involves premixing of fuel and air to form a lean mixture thereof prior to the combustion. However, it has been shown that for heavy duty industrial gas turbines, even with the use of premixed lean fuels, the required temperatures of the combustion products are so high that the combustor must be operated with peak gas temperatures in the reaction zone that exceeds the thermal NOx formation threshold temperature, resulting in significant NOx formation.

Another existing solution for controlling a temperature profile involves injecting liquid fuel into the transition piece as part of staged combustion process. However, in this case, the walls of the transition piece(s) may have undesirably high temperatures, and, moreover, there may be various non-uniformities in the exit temperature profile. Typically, addition of dilution air into the transition piece(s) is used to adjust the exit temperature profile, but this approach does not always provide accurate adjustments to achieve desired combustor exit temperature profiles. This may be due to poor penetration of liquid fuel droplets into high velocity cross flow of combustion gases from the upstream end of the transition piece.

### BRIEF SUMMARY OF THE DISCLOSURE

Certain embodiments of the disclosure may include systems and methods for pulse-width modulation of late lean liquid injection velocity.

According to one embodiment of the disclosure, there is provided a gas turbine combustor. The gas turbine combustor may include a combustor liner configured to mix a first fuel and air to produce combustion gases. The combustor liner may include an upstream end and a downstream end. The gas turbine combustor may further include a transition piece operatively connected to the downstream end of the combustor liner, which is configured to transit the combustion gases to a gas turbine. The gas turbine combustor may further include one or more injectors, which are structurally supported by the transition piece and configured to repeatedly introduce a second fuel into the transition piece. The gas turbine combustor may also include a controller configured to dynamically control a velocity of the second fuel introduced into the transition piece through the one or more injectors.

According to embodiment of the disclosure, there is provided a method for controlling a combustor exit temperature profile. The method may include the steps of flowing combustion gases through a transition piece of a gas turbine combustor, repeatedly introducing a fuel into the transition piece through one or more injectors, wherein the introduction of the fuel into the transition piece is based on a duty cycle, and dynamically modifying the duty cycle by a controller to achieve a desired combustor exit temperature profile.

According to another embodiment of the disclosure, there is provided a system for controlling a combustor exit temperature profile. The system may include one or more actuators operatively coupled to one or more injectors and a controller. The controller may be configured to generate a duty cycle signal, which repeatedly operates the one or more actuators to introduce a fuel into a transition piece of a gas combustor, receive modulation information associated with a measured combustor exit temperature profile, and apply PWM to duty cycle signal based at least in part on the measured combustor exit temperature profile. The modulation information may include a deviation of the measured combustor exit temperature profile and a pre-set desired combustor exit temperature profile.

Additional systems, methods, apparatuses, features, and aspects are realized through the techniques of various embodiments of the disclosure. Other embodiments and aspects of the disclosure are described in detail herein and are considered a part of the claimed disclosure. Other embodiments and aspects can be understood with reference to the description and the drawings.

### BRIEF DESCRIPTION OF THE DRAWINGS

Having thus described the disclosure in general terms, reference will now be made to the accompanying drawings, which are not necessarily drawn to scale, and wherein:

FIG. 1 illustrates a high level diagram of an example gas turbine combustor, according to embodiments of the disclosure.

FIG. 2 illustrates a high level diagram of an example gas turbine combustor, according to an embodiment of the disclosure.

FIG. 3 shows a flow diagram illustrating an example method for controlling a combustor exit temperature profile of the gas turbine combustor according to an embodiment of the disclosure.

### DETAILED DESCRIPTION

Illustrative embodiments of the disclosure will now be described more fully hereinafter with reference to the accompanying drawings, in which some but not all embodiments of the disclosure may be shown. Indeed, the disclosure may be embodied in many different forms and should not be construed as limited to the embodiments set forth herein; rather, these embodiments are provided so that this disclosure satisfies applicable legal requirements. Like numbers refer to like elements throughout.

Certain embodiments of the disclosure relate to methods and systems to pulse-width modulation of late lean liquid injection velocity. In certain embodiments, intelligent control of a temperature profile of combustion gases within a transition piece in a late lean injection scheme can be obtained before the combustion gases are flown into a gas turbine. The late lean injection scheme may involve introduction of liquid fuel into the transition piece so as to improve fuel penetration and an exhaust temperature profile. While existing systems may provide fuel typically leading to poor fuel droplets penetration and as a result excessive heating of transition piece walls, certain embodiments of the disclosure can allow for intelligently controlling velocity of the fuel when the fuel is introduced into the system. In particular, certain embodiments of the disclosure can provide for PWM of duty cycle signal used for fuel injection, which in turn permits varying a fuel injection velocity for a given fuel flow rate. Further, certain embodiments of the disclosure may provide for higher injection velocities, thereby moving a heat release zone away from the transition piece walls and providing for modification of the combustion gases temperature profile within the transition piece and, in particular, at a downstream end of the transition piece.

The modification or adjustment of the duty cycle signal and, thus, the temperature profile, may optionally be performed dynamically, in real time, and/or may be based on a real-time feedback. In certain embodiments, the temperatures of the combustion gases or combustion gases temperature profile may be measured and continuously monitored. The measured data may be included in the feedback and used to modify the PWM process of adjusting the duty cycle. Accordingly, the PWM modification of duty cycle may affect the velocity of fuel injection and, therefore, the fuel penetration conditions within the transition piece.

Various system components for efficient controlling of the temperature profile of combustion gases within the transition piece of the gas turbine will now be described with reference to the accompanying drawings.

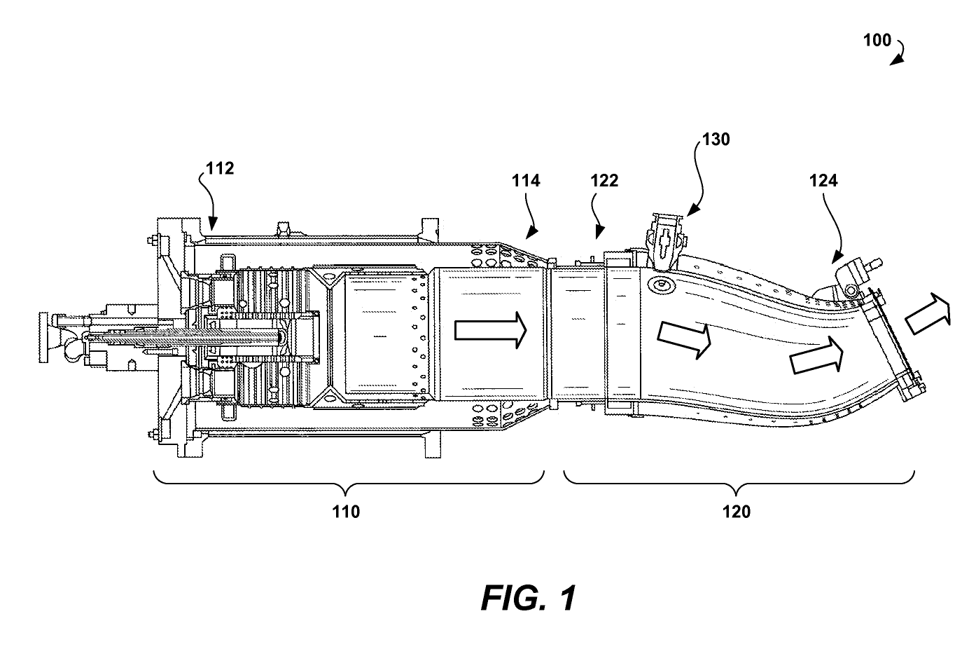

FIG. 1 illustrates a high level diagram of a gas turbine combustor 100 (partially shown), according to example embodiments of the disclosure. The gas turbine combustor 100 includes a combustor liner 110 configured, generally speaking, to introduce various airflows and liquids (fuel) into its interior (also known as a combustion zone) to mix them and run a combustion process. Combustion gases are generated as a result of the combustion process, and are then exhausted into a transition piece (duct) 120 by moving from a combustor liner upstream end 112 to a combustor liner downstream end 114. The transition piece 120 is used for moving the combustion gases further (i.e., from an upstream end 122 of the transition piece 120 to a downstream end 124 of the transition piece 120 and then to a first stage of a gas turbine (not shown)).

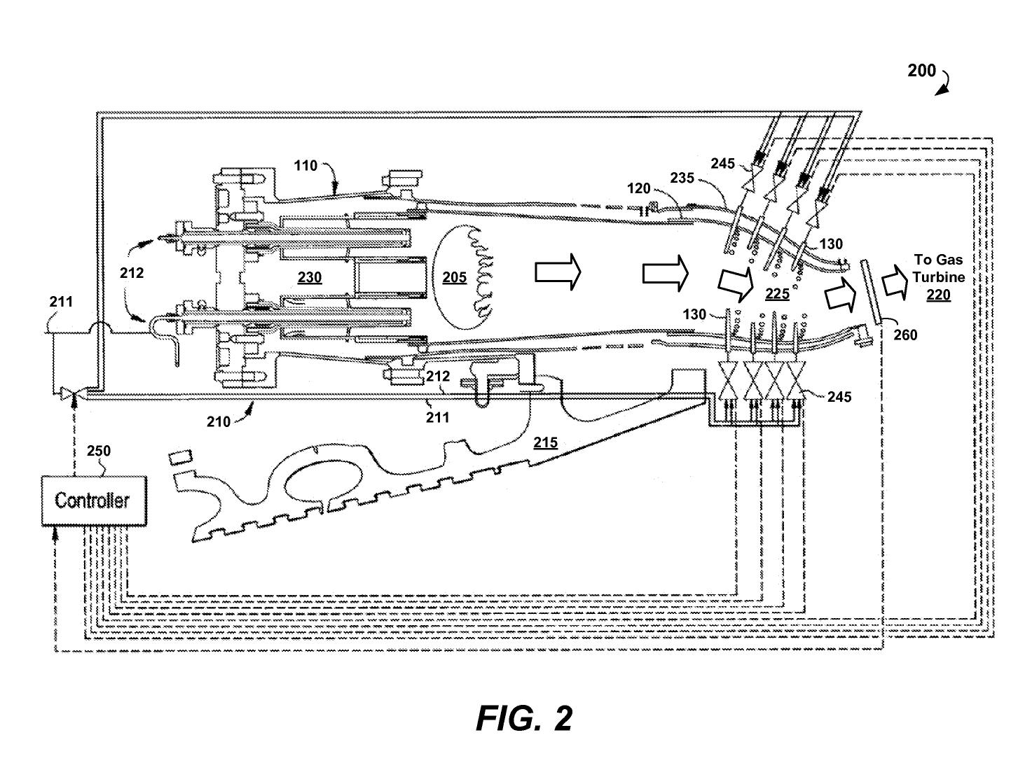

Still referencing FIG. 1, the transition piece 120 may include an injector 130 for introducing fuel or a fuel-air mixture into the transition piece 120. Although it is shown just one injector 130, in certain embodiments there may be provided a plurality of injectors 130 as shown in FIG. 2. The injector 130 may include an injection nozzle having an orifice through which the fuel or fuel-air mixture is delivered into the interior of the transition piece 120. This orifice may have a fixed size (diameter) or it may be varied.

In the case when the orifice size is fixed and the fuel rate is also constant, the velocity of fuel injection may depend on a time interval during which an actuator connected to the injector 130 is opened and the fuel is delivered to and goes through the orifice. If this time interval is shortened, the fuel will go through the orifice with a higher velocity, and vice versa.

In the case, when the orifice size can be varied (e.g., by utilizing a hydraulic poppet actuator), and provided the fuel flow rate is constant, the variation of orifice size may change the fuel injection velocity. By merely increasing the orifice size, the fuel injection rate may be decreased, and vice versa.

In certain embodiments, the injector(s) 130 may include an electro-mechanical actuator (not shown) to repeatedly provide fuel to the injector nozzle and introduce the fuel into the transition piece 120. In other embodiments, the injector(s) 130 may include an ultrasonic liquid fuel injection device (not shown) for injecting pressurized fuel into the transition piece 120. Some examples of applicable ultrasonic liquid fuel injection devices are described in the U.S. utility patent application Ser. No. 10/113,618, titled “Ultrasonic Liquid Fuel Injection Apparatus and Method,” filed on Apr. 1, 2002.

The fuel injection velocity may be selected based on a predetermined scheme (e.g., based on a turbine operating regime or fuel-air mixture condition) or it may optionally depend on a feedback obtained from a monitoring device. The feedback may refer to measured or indirectly determined temperatures of the combustion gases present within the transition piece 120. In certain embodiments, the feedback may include or be associated with a temperature profile of combustion gases measured at the downstream end 124 of the transition piece 120.

It should be also noted that the fuel injector 130 may extend inside the interior of the transition piece 120 at a predetermined distance. In certain embodiments, the distance of extending of the transition piece 120 may vary based on the feedback or other operating parameters. Further, the orientation and angle of the injector nozzle may be changed based on an operating regime or predetermined parameters. In case a plurality of injectors 130 utilized, each injector of this plurality may have unique length and orientation.

FIG. 2 illustrates a high level diagram of a gas turbine combustor 200 (partially shown) according to another, more detailed example embodiment of the present disclosure. The gas turbine combustor 200 includes a combustor liner 110 having a first interior 205 in which a first fuel supplied thereto by fuel circuit 210 is combustible, a compressor 215 by which inlet air is compressed and provided to at least the combustor liner 110 and a transition piece 120 and a gas turbine 220, including rotating turbine blades, into which products of at least the combustion of the first fuel are receivable to power a rotation of the turbine blades. The transition piece 120 is disposed to fluidly couple the combustor liner 110 and the turbine 220 and includes a second interior 225 in which a second fuel supplied thereto by the fuel circuit 210 via one or more premixing nozzles 212 and the products of the combustion of the first fuel are combustible. As shown, the combustor liner 110 and the transition piece 120 combine with one another to generally have a form of a head end 230, which may have various configurations. For each of the head end 230 configurations, it is understood that versions of the configurations may be late lean injection (LLI) compatible.

A plurality of fuel injectors 130 are each structurally supported by an exterior wall of the transition piece 120 or by an exterior wall of a sleeve 235 around the transition piece 120. As an example, the plurality of fuel injectors 130 extends into the second interior 225 to varying depths. With this configuration, the fuel injectors 130 are each configured to provide LLI fuel staging capability. That is, the fuel injectors 130 are each configured to supply the second fuel (i.e., LLI fuel, which may differ from the first fuel) or a specific fuel-air mixture to the second interior 225 by, e.g., fuel injection in a direction that is generally transverse to a predominant flow direction through the transition piece 120, in any one of a single axial stage, multiple axial stages, a single axial circumferential stage, and multiple axial circumferential stages. In so doing, conditions within the combustor liner 110 and the transition piece 120 are staged to create local zones of stable combustion.

In accordance with embodiments of the present disclosure, the single axial stage may include a currently operating single fuel injector 130, the multiple axial stages may include multiple currently operating fuel injectors 130, which are respectively disposed at multiple axial locations of the transition piece 120, the single axial circumferential stage may include multiple currently operating fuel injectors 130 respectively disposed around a circumference of a single axial location of the transition piece 130, and the multiple axial circumferential stages may include multiple currently operating fuel injectors 130, which are disposed around a circumference of the transition piece 120 at multiple axial locations thereof.

Furthermore, where multiple fuel injectors 130 are disposed around a circumference of the transition piece 120, the fuel injectors 130 may be spaced substantially evenly or unevenly from one another. As an example, eight or ten fuel injectors 130 may be employed at a particular circumferential stage with 2, 3, 4, or 5 fuel injectors 130 installed with varying degrees of separation from one another on northern and southern hemispheres of the transition piece 120. Also, where multiple fuel injectors 130 are disposed at multiple axial stages of the transition piece 120, the fuel injectors 130 may be in-line and/or staggered with respect to one another.

During operations of the gas turbine combustor 100, each of the fuel injectors 130 may be jointly or separately activated or deactivated so as to form the currently effective one of the single axial stage, the multiple axial stages, the single axial circumferential stage, and the multiple axial circumferential stages. To this end, it is understood that the fuel injectors 130 may each be supplied with LLI fuel by way of the fuel circuit 210 via one or more actuators 245 (e.g., electromechanical valves) disposed between a corresponding fuel injector 130 and a branch 211 or 212 of the fuel circuit 210. The actuators 245 may operatively communicate with a controller 250 that sends signals to the actuators 245 that cause the actuators 245 to open or close and to thereby activate or deactivate the corresponding fuel injectors 130.

Thus, if it is currently desirable to have each fuel injector 130 currently activated (i.e., multiple axial circumferential stages), the controller 250 signals to each of the actuators 245 to open and thereby activate each of the fuel injectors 130. Conversely, if it is currently desirable to have each fuel injector 130 of a particular axial stage of the transition piece 120 currently activated (i.e., single axial circumferential stage), the controller 250 signals to each of the actuators 245 corresponding to only the fuel injectors 130 of the single axial circumferential stage to open and thereby activate each of the fuel injectors 130. Of course, this control system is merely exemplary and it is understood that multiple combinations of fuel injector configurations are possible and that other systems and methods for controlling at least one of the activation and deactivation of the fuel injectors 130 are available.

It should be also understood that the actuators 245 may couple the injectors not only with the fuel circuit 210, but also with an air ducts so that a fuel-air mixture can be generated within the injector(s) 130 or in a proximity thereto.

Still referring to FIG. 2, there may be provided a monitoring device 260 arranged at the downstream end (aft) of the transition piece 120. In certain embodiments, monitoring device 260 may measure a temperature of combustion gases going through it or measure a temperature profile of combustion gases going through it. The measurements may be performed in real time or repeatedly. The measured data may be then delivered to the controller 250 via a wired or wireless communication link. As discussed herein, the measured data may relate to feedback. Those skilled in the art should also understand that the monitoring device may also (or instead of) measure temperature of the walls of the transition piece 120. In yet more embodiments, the monitoring device 260 may measure or detect various non-uniformities of the combustion gases or vortices.

According to various embodiments of the present disclosure, the controller 250 may generate a duty cycle signal, which may include a meander-like signal or, more specifically, rectangular waveform signal. The controller 250 sends the duty cycle signal to the actuators 245 to repeatedly activate and deactivate them (i.e., open and close) so as to repeatedly inject fuel into the transition piece 120 via the injectors 130. The duty cycle signal may be characterized by a pulse duration and a period of a rectangular waveform.

In various embodiments, the controller 250 may control and adjust the duty cycle signal by applying a PWM. The PWM may be based on modulation information, which may be predetermined and depend on a particular turbine operating scheme, or it may be dynamically changed based on the feedback data (i.e., a temperature profile of combustion gases as measured by the monitoring device 260). Accordingly, the PWM may increase/decrease the pulse duration mentioned above and/or increase/decrease the period of rectangular waveform. In certain embodiments, such modification may dynamically and in real time lengthen or shorten operating times of the actuators 245 (i.e., valves) during which the fuel is introduced into the transition piece 120. Accordingly, if the fuel is injected at a set flow rate through the injectors 130, the velocity of fuel injection is also either increased or decreased by changing the operating times. In yet other embodiments, said modification affects the orifice size of the injectors 130. By PWM modification, the orifice size may be either enlarged or decreased and thereby the velocity of fuel injection can be increased or decreased. In either case, by adjusting the velocity of fuel injection, a heat release zone may be moved within the transition piece 120. More specifically, since the distance this heat release zone is from the injector 130 (or an injector point) is a function of the duty cycle, the duty cycle modification may adjust a position of the heat release zone.

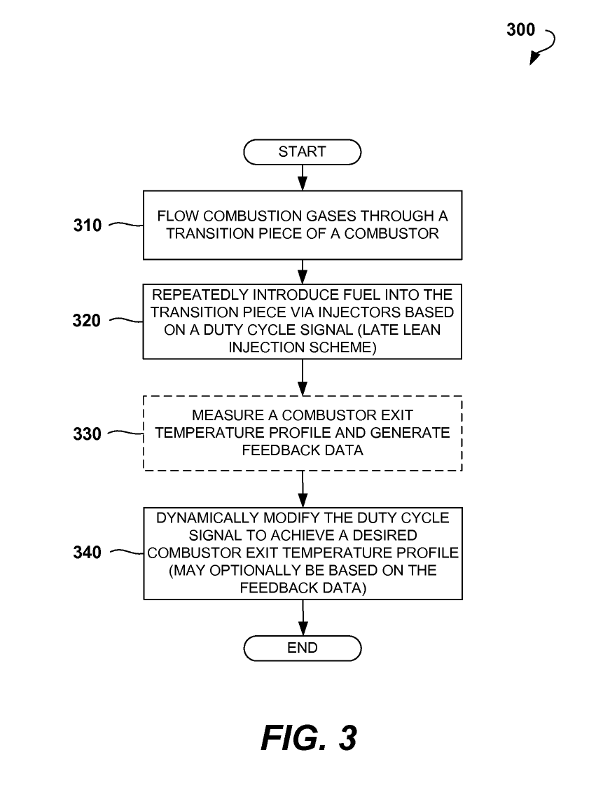

FIG. 3 shows an example flow diagram illustrating a method 300 for controlling a combustor exit temperature profile of the gas turbine combustor 100, 200. The method 300 may be implemented by elements of the gas turbine combustors 100, 200 as described herein with reference to FIGS. 1 and 2.

The method 300 may commence in operation 310 with the gas turbine combustors 100, 200 flowing combustion gases through the transition piece 120. The combustion gases may be generated in the combustion liner 110 by mixing a first fuel and air to combust a fuel-air mixture. Typically, the combustion gases are transmitted from the upstream end 122 of the transition piece 120 towards the downstream end 124 of transition piece 120.

At operation 320, a late lean injection scheme is implemented. More specifically, the injector(s) 130, in combination with the corresponding actuator(s) 245 and the controller 250, repeatedly introduce a fuel (or a fuel-air mixture or any other liquid) into the transition piece 120. The controller 250 may generate a duty cycle signal supplied to the actuator(s) 245 so as to repeatedly trigger (i.e., open and close) the actuator(s) 245 to circularly inject the fuel (e.g., in the form of a spray) into the transition piece 120. As described above, the injection may be periodic so as late lean injection stage is implemented.

At operation 330, the monitoring device 260 may optionally and periodically measure a combustor exit temperature profile. The measurements may be either direct or indirect. For example, in certain embodiments, the temperatures of transition piece walls may be measured. In yet additional embodiments, the monitoring device 260 may detect non-uniformities in the flow of combustion gases and/or temperatures at certain locations. In either case, the monitoring device 260 may optionally generate feedback data. In yet additional embodiments, the feedback data may relate to a difference between the measured combustor exit temperature profile and a pre-set desired combustor exit temperature profile.

At operation 340, the controller 250 may dynamically modify the duty cycle to achieve a desired combustor exit temperature profile. In particular, the controller 250 may modify the duty cycle signal utilizing, for example, a PWM. The PWM in turn may be based on the feedback data. As described herein with relation to multiple embodiments, the dynamic modification of the duty cycle signal changes a velocity of fuel introduction from the one or more injectors 130 into the transition piece 120.

Thus, there have been described various gas turbine combustors 100, 200 involving a late lean injection and corresponding methods for controlling a combustor exit temperature profile. The embodiments described herein allow for dynamic and intelligent adjustment of late lean injection, and thus fuel introduction velocity, so as to improve fuel droplet penetration and moving the heat release zone away from the walls of the transitional piece 120. Although the embodiments have been described with reference to specific example embodiments, it will be evident that various modifications and changes can be made to these example embodiments without departing from the broader scope of the application. Accordingly, the specification and drawings are to be regarded in an illustrative rather than a restrictive sense.

It should be noted that at least some aspects of the embodiments disclosed herein may be implemented using a variety of technologies including, for example, firmware or software codes that may be executed on any suitable computing system or in hardware utilizing a microprocessor, controller, microcontroller, chip, specially designed application-specific integrated circuits (ASICs), programmable logic devices, or any combination thereof. In particular, the methods described herein may be implemented by a series of computer-executable instructions residing on a storage medium such as a disk drive or computer-readable medium. It should be noted that at least some aspects of the embodiments disclosed herein can be implemented by a computer.

One may appreciate that information and signals described herein may be represented using any of a variety of different technologies and techniques. For example, data, instructions, commands, information, signals, bits, symbols, codes, and chips that are referenced throughout the description can be represented by voltages, currents, electromagnetic waves, magnetic fields or particles, or any combination thereof.

The following detailed description is therefore not to be taken in a limiting sense, and the scope is defined by the appended claims and their equivalents. In this document, the terms “a” and “an” are used, as is common in patent documents, to include one or more than one.

In this document, the term “or” is used to refer to a nonexclusive “or,” such that “A or B” includes “A but not B,” “B but not A,” and “A and B,” unless otherwise indicated.

What is claimed is:

1. A gas turbine combustor comprising:
a combustor liner configured to mix a first fuel and air to produce combustion gases, the combustor liner including an upstream end and a downstream end;
a transition piece operatively connected to the downstream end of the combustor liner, the transition piece being configured to transit the combustion gases to a gas turbine;
one or more injectors structurally supported by the transition piece and configured to repeatedly introduce a second fuel into the transition piece; and
a controller configured to control a velocity of the second fuel introduced into the transition piece through the one or more injectors.

2. The gas turbine combustor of claim 1, wherein the controller is further configured to control operating times of the introduction of the second fuel into the transition piece through the one or more injectors having fixed size injection orifices to control the velocity of the second fuel introduction.

3. The gas turbine combustor of claim 1, wherein the controller is further configured to repeatedly control sizes of injection orifices associated with the one or more injectors to control the velocity of the second fuel introduction.

4. The gas turbine combustor of claim 1, wherein the controller is further configured to selectively modify a duty cycle to control the velocity of the second fuel introduction into the transition piece.

5. The gas turbine combustor of claim 4, wherein the selective modification of the duty cycle includes pulse-width modulation (PWM) of a duty cycle signal.

6. The gas turbine combustor of claim 5, wherein the PWM is based at least in part on modulator signal information, the modulator signal information being associated with a combustor exit temperature profile.

7. The gas turbine combustor of claim 5, wherein the PWM is based at least in part on modulator signal information, the modulator signal information relating to a deviation of a current combustor exit temperature profile and a desired combustor exit temperature profile.

8. The gas turbine combustor of claim 1, wherein each of the one or more injectors includes an electronic actuator, the electronic actuator being operatively coupled to the controller.

9. The gas turbine combustor of claim 1, wherein each of the one or more injectors includes an ultrasonic liquid fuel injection device, the ultrasonic liquid fuel injection device being operatively coupled to the controller.

10. The gas turbine combustor of claim 1, further comprising a monitoring device attached to a downstream end of the transition piece, wherein the monitoring device is configured to dynamically measure a combustor exit temperature profile.

11. The gas turbine combustor of claim 1, wherein the second fuel includes a fuel-air mixture.

12. A method for controlling a combustor exit temperature profile, the method comprising:
flowing combustion gases through a transition piece of a gas turbine combustor;
repeatedly introducing a fuel into the transition piece through one or more injectors, wherein the introduction of the fuel into the transition piece is based at least in part on a duty cycle; and
dynamically modifying the duty cycle by a controller to achieve a desired combustor exit temperature profile.

13. The method of claim 12, further comprising periodically measuring, by a monitoring device, a combustor exit temperature profile.

14. The method of claim 13, further comprising:
comparing, by the controller, the combustor exit temperature profile to a pre-set desired combustor exit temperature profile; and
based at least in part on the comparison, dynamically modifying the duty cycle by the controller.

15. The method of claim 14, wherein the dynamic modification of the duty cycle includes pulse-width modulation (PWM) of a duty cycle signal.

16. The method of claim 12, wherein the dynamic modification of the duty cycle varies a velocity of fuel introduction from the one or more injectors into the transition piece.

17. The method of claim 16, wherein the velocity of the fuel introduction is varied by regulating introduction times of the fuel through the one or more injectors having fixed size injection orifices.

18. The method of claim 16, wherein the velocity of fuel introduction is varied by regulating sizes of injection orifices associated with the one or more injectors.

19. A system for controlling a combustor exit temperature profile, the system comprising:
one or more actuators operatively coupled to one or more injectors; and
a controller configured to:
generate a duty cycle signal to repeatedly operate the one or more actuators, the one or more actuators configured to introduce a fuel into a transition piece of a gas combustor;
receive modulation information associated with a measured combustor exit temperature profile; and
apply pulse-width modulation (PWM) to a duty cycle signal based at least in part on the measured combustor exit temperature profile.

20. The system of claim 19, wherein the modulation information includes a deviation of a measured combustor exit temperature profile and a pre-set desired combustor exit temperature profile.
